(19) United States
(12) Patent Application Publication
(10) Pub. No.: US 2023/0084778 A1
(43) Pub. Date: Mar. 16, 2023

(54) EXPLOSION-PROOF VALVE APPLICABLE TO BATTERY, BATTERY, AND ENERGY STORAGE DEVICE

(71) Applicant: Xiamen Hithium Energy Storage Technology Co., Ltd., Xiamen (CN)

(72) Inventors: Bo HE, Xiamen (CN); Nan ZHANG, Xiamen (CN); Weidong XU, Xiamen (CN); Ziqi YI, Xiamen (CN); Zuyu WU, Xiamen (CN)

(73) Assignee: Xiamen Hithium Energy Storage Technology Co., Ltd., Xiamen (CN)

(21) Appl. No.: 17/903,526

(22) Filed: Sep. 6, 2022

(30) Foreign Application Priority Data
Sep. 10, 2021 (CN) 202122186982.6

(51) Int. Cl. H01M 50/342; H01M 50/152

(52) U.S. Cl. CPC H01M 50/3425; H01M 50/152

(57) ABSTRACT

An explosion-proof valve applicable to a battery, the battery, and an energy storage device are provided in the present disclosure. The energy storage device includes the battery. The battery includes the explosion-proof valve, a housing, a winding core, and a top cover assembly. The explosion-proof valve applicable to the battery includes a body, a first notch groove, and at least one second notch groove. The first notch groove is defined on a side surface of the body. The at least one second notch groove is defined on a groove wall of the first notch groove. The winding core is located in the housing. The top cover assembly seals the housing, where the explosion-proof valve is installed in the top cover assembly, and the first notch groove is defined at a side of the top cover assembly close to the winding core.

### CROSS-REFERENCE TO RELATED APPLICATIONS

This application claims, under 35 U.S.C. § 119(a), priority to and the benefit of Chinese Patent Application No. 202122186982.6, filed on Sep. 10, 2021, the entire disclosure of which is incorporated herein by reference.

### TECHNICAL FIELD

This disclosure relates to the technical field of batteries, and in particular to an explosion-proof valve applicable to a battery, the battery, and an energy storage device.

### BACKGROUND

As a new type of environmental protection energy, batteries have been widely used in automobile, high-speed rail, aerospace, electronic devices, and other fields.

In related art, an explosion-proof valve and a battery cell are disposed in the battery, and a gas will be generated in a usage process of the battery cell, which will lead to increasing of an air pressure inside the battery. When the air pressure exceeds a certain pressure value, the explosion-proof valve will be opened to release an inner gas, thereby avoiding explosion. However, if the explosion-proof valve has inferior stability and is exploded in advance or unable to be exploded in time, safety performance of the battery will be affected. Therefore, how to ensure explosion stability of the explosion-proof valve has become an urgent problem to be solved.

### SUMMARY

According to implementations of a first aspect of the present disclosure, an explosion-proof valve applicable to a battery includes a body, a first notch groove, and at least one second notch groove. The first notch groove is defined on a side surface of the body. The at least one second notch groove is defined on a groove wall of the first notch groove.

According to implementations of a second aspect of the present disclosure, a battery includes an explosion-proof valve applicable to the battery, a housing, a winding core, and a top cover assembly. The explosion-proof valve includes a body, a first notch groove, and at least one second notch groove. The first notch groove is defined on a side surface of the body. The at least one second notch groove is defined on a groove wall of the first notch groove. The winding core is located in the housing. The top cover assembly seals the housing, where the explosion-proof valve is installed in the top cover assembly, and the first notch groove is defined at a side of the top cover assembly close to the winding core.

According to implementations of a third aspect of the present disclosure, an energy storage device includes a battery. The battery includes an explosion-proof valve applicable to the battery, a housing, a winding core, and a top cover assembly. The explosion-proof valve includes a body, a first notch groove, and at least one second notch groove. The first notch groove is defined on a side surface of the body. The at least one second notch groove is defined on a groove wall of the first notch groove. The winding core is located in the housing. The top cover assembly seals the housing, where the explosion-proof valve is installed in the top cover assembly, and the first notch groove is defined at a side of the top cover assembly close to the winding core.

Some of additional aspects and advantages of the present disclosure will be provided in the following descriptions, and some will become obvious in the following descriptions or be learned from practice of the present disclosure.

### BRIEF DESCRIPTION OF THE DRAWINGS

The above and/or additional aspects and advantages of the present disclosure will become obvious and easy to be understood in the descriptions of the implementations with reference to the following accompanying drawings:

FIG. 1 is a schematic diagram of a body of an explosion-proof valve according to the present disclosure.

FIG. 2 is a schematic cross-sectional diagram of a body of an explosion-proof valve according to the present disclosure.

FIG. 3 is an enlarged schematic diagram at P region in FIG. 2.

FIG. 4 is a schematic cross-sectional diagram of a battery according to the present disclosure.

FIG. 5 is a schematic diagram of an energy storage device according to the present disclosure.

Reference signs of the accompanying drawings include the following: explosion-proof valve 100; body 10; first notch groove 11; second notch groove 12; boss 13; battery 200; housing 201; winding core 202; top cover assembly 203; energy storage device 300.

### DETAILED DESCRIPTION

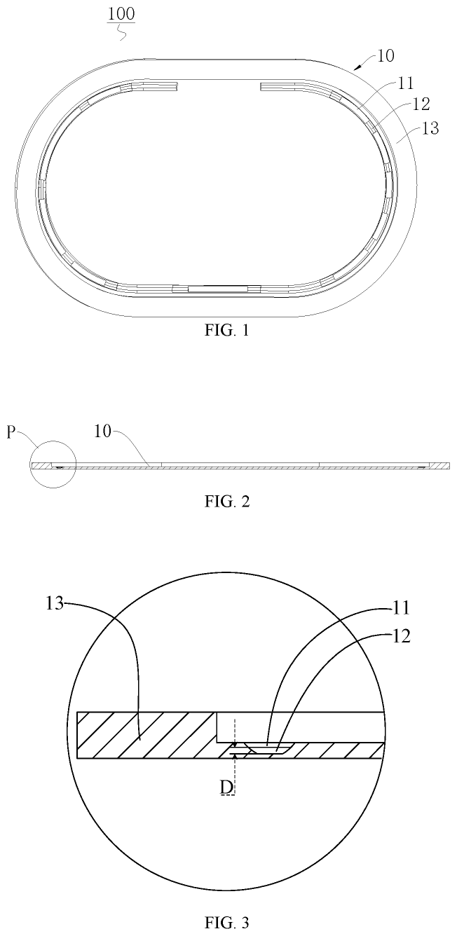

The following describes implementations of the present disclosure in detail. The implementations described with reference to the accompanying drawings are exemplary. Reference can be made to FIG. 1 to FIG. 5, and the following describes an explosion-proof 100 applicable to a battery 200, the battery 200, and an energy storage device 300 according to the implementations of the present disclosure.

According to a first aspect of implementations of the present disclosure, an explosion-proof valve 100 applicable to a battery 200 includes a body 10, a first notch groove 11, and at least one second notch groove 12.

Specifically, reference can be made to FIG. 1 to FIG. 3, the first notch groove 11 is defined on a side surface of the body 10, and the at least one second notch groove 12 is defined on a groove wall of the first notch groove 11. In the present disclosure, compared with an explosion position with the same thickness in related art, the first notch groove 11 and the at least one second notch groove 12 are defined, such that a height difference is formed between a groove wall of the first notch groove 11 and a groove wall of each of the at least one second notch groove 12, and the body 10 can have different thicknesses to form gradients. Therefore, the at least one second notch groove 12 is defined to help to change a thickness of the body 10 according to actual requirements. Here, “groove wall” may mean a side wall or a bottom wall of the first notch groove 11 or each of the at least one second notch groove 12. For example, there is a height difference between a bottom wall of the first notch groove 11 and a bottom wall of each of the at least one second notch groove 12.

Therefore, the first notch groove 11 defines the at least one second notch groove 12 on the groove wall of the first notch groove 11. By defining the at least one second notch groove 12, a notch depth of the explosion-proof valve 100 can present multiple gradients, an explosion region of the body 10 can have different thicknesses, an explosion pressure can be concentrated at a position where the at least one second notch groove 12 is defined, the explosion pressure can be more concentrated, accuracy and concentration of explosion and stability of an explosion-proof pressure are improved, a possibility that an inner pressure is released from the at least one second notch groove 12 when the explosion-proof valve 100 is exploded is increased, the explosion-proof valve 100 can be exploded in a particular direction at a designated position according to a preset explosion region, and safety of the explosion-proof valve is improved.

Optionally, reference can be made to FIG. 1, the explosion-proof valve 100 includes multiple second notch grooves 12, and the multiple second notch grooves 12 are arranged at intervals in a length direction of the first notch groove 11. The length direction of the first notch groove 11 is a circumferential direction of the body 10, the first notch groove 11 extends in the circumferential direction of the body 10, an extension length of each of the multiple second notch grooves 12 in the circumferential direction is smaller than an extension length of the first notch groove 11 in the circumferential direction, and the multiple second notch grooves 12 are arranged at intervals in the length direction of the first notch groove 11. Of course, second notch grooves 12 may have different depths, such that the body 10 has different thicknesses, a position where it is easier to be exploded is flexibly set according to actual requirements, and stability of an explosion value is improved.

Therefore, the first notch groove 11 defines the multiple second notch grooves 12 arranged at intervals on the groove wall of the first notch groove 11, such that a structural strength of the body 10 of the explosion-proof valve 100 is improved, and the explosion-proof valve 100 can be exploded at a preset weak region when the explosion-proof valve 100 is exploded, which improves controllability and safety of explosion and enables an explosion value at the at least one second notch groove 12 to be more stable.

Specifically, at least two of the multiple second notch grooves have different lengths. For example, lengths of second notch grooves 12 adjacent to each other or lengths of two second notch grooves 12 spaced by multiple second notch grooves 12 are different in the length direction of the first notch groove 11 of the body 10. Therefore, at least two second notch grooves 12 are defined to have different lengths, such that stability of a weak region formed by defining the at least one second notch groove 12 on the explosion-proof valve 100 can be improved, which helps to enable the explosion-proof valve 100 to be appliable to more batteries 200 according to actuality.

In some implementations, each of the at least one second notch groove 12 has a width smaller than the first notch groove 11. The at least one second notch groove 12 is defined on a bottom of the first notch groove 11, and each of the at least one second notch groove 12 has a width smaller than the first notch groove in a radial direction of the body 10. Therefore, each of the at least one second notch groove 12 has the width smaller than the first notch groove 11, such that a structural strength of a notch-groove region can be improved, and a flow speed of airstream can be accelerated after explosion airstream breaks through the at least one second notch groove 12, which avoids a secondary damage, facilitates implementations of manufacturing processes, and reduces manufacturing costs.

Furthermore, each of the least one second notch groove 12 has a polygonal cross-section or a semicircular cross-section. A polygon may be one of a V-shape, a trapezoid, and a square. For example, when a cross-section is semicircular, each of the least one second notch grooves 12 can have smooth transition between the bottom wall of each of the least one second notch groove 12 and the bottom wall of the first notch groove 11, such that the cross section of each of the at least one second notch groove 12 can be semicircular, which helps to improve stability of explosion and facilitates processing. Therefore, cross-sectional shapes of the at least one second notch grooves 12 are various, and different second notch grooves 12 can be designed according to actual usage situations, such that a diversity of selection of the at least one second notch grooves 12 is improved.

In some implementations, the body 10 is provided with a boss 13 at an edge of the side surface of the body 10, the first notch groove 11 is adjacent to the boss 13, and the first notch groove 11 is located at a radially inner side of the boss 13, that is, the first notch groove 11 is closer to a center of the body 10 than the boss 13.

Reference can be made to FIG. 1 and FIG. 3, and the boss 13 is formed at the edge of the side surface of the body 10, e.g., the boss 13 is formed at the side surface of the body 10 where an opening of the first notch groove 11 faces. The boss 13 can be integrally formed with the body 10, the boss 13 can have a width larger than the first notch groove 11 in the radial direction of the body 10, the first notch groove 11 is spaced apart from the boss 13, and the first notch groove 11 is closer to a center of the body 10 than the boss 13.

Therefore, the body 10 is provided with the boss 13 at the edge of the side surface of the body 10, to facilitate a connection between the body 10 and a component to be installed (which may be a top cover assembly 203 in which the explosion-proof valve 100 is installed). A specific connection manner may be a fixed connection by welding, such that an influence on a structure of the first notch groove 11 in a welding process can be effectively avoided, the first notch groove 11 can be exploded according to a preset condition when explosion is needed, thereby preventing structural strengths of the first notch groove 11 and the at least one second notch groove 12 from being improved due to welding and slagging of welding slag, which increases a possibility that the explosion-proof valve 100 is successively exploded, and helps to safety usage of a battery 200.

Reference can be made to FIG. 1, the first notch groove 11 extends in an extension direction of the boss 13, and two ends of the first notch groove 13 are spaced apart. The boss 13 forms an elliptical ring-shaped boss 13 in the circumferential direction of the body 10, the boss 13 is located in the circumferential direction of the body 10, the first notch groove 11 is defined at the body 10, the first notch groove 11 does not form a closed loop in the circumferential direction of the body 10, and an interval is formed between the two ends of the first notch groove 11.

Therefore, the two ends of the first notch groove 11 extending in the circumferential direction of the body 10 are not connected with each other and the interval is formed, which can prevent the body 10 from being separated from the boss 13 when the explosion-proof valve 100 is exploded, and prevent the body 10 from being divided into two parts due to falling off of the body 10, thus increasing safety of using the explosion-proof valve 100.

In some implementations, reference can be made to FIG. 3, the at least one second notch groove 12 is defined on the bottom wall of the first notch groove 11 (a groove wall opposite to the opening of the first notch groove 11), a distance between the bottom wall of the first notch groove 13 and the bottom wall of each of the at least one second notch groove 12 is D, where D satisfies 0.015 mm≤D≤0.025 mm. For example, D=0.02 mm. Therefore, a distance between a center of the bottom wall of the first notch groove 11 and a center of the bottom wall of each of the at least one second notch groove 12 is controlled, such that structural strengths of the first notch groove 11 and the at least one second notch groove 12 are improved, and reliability of the explosion-proof valve 100 is improved.

For example, the first notch groove 11 can be implemented as one first notch groove 11, and the first notch groove 11 is elliptical ring-shaped and extends in the circumferential direction of the body 10. The at least one second notch groove 12 can be implemented as multiple second notch grooves 12 arranged at intervals, and the multiple second notch grooves 12 may have the same depth or different depths. The body 10 can be provided with the boss 13 at an edge of the body 10, and the boss 13 can be configured to be connected with other components by welding, etc. The at least one second notch groove 12 is located on a different plane from the boss 13, and when the boss 13 is connected with other components by welding, reliability of the at least one second notch groove 12 can be prevented from being affected during welding. At the same time, the first notch groove 11 may be elliptical ring-shaped, and the at least one second notch groove 12 may be located at a position where the first notch groove 11 bends or a position where the first notch groove 11 extends along a straight line, which is not limited here and can be specifically set according to actual requirements, thereby ensuring that explosion regions of the explosion-proof valve 100 are more concentrated and stable.

Two notch grooves of the explosion-proof valve 100 defined in this manner are simply processed, and both of them can be punched to form groove structures by a notched process, so as to reduce a thickness of the body 10. At the same time, since an explosion value of the explosion-proof valve 100 disposed in this manner is more stable, and domestic materials can be used to replace imported materials to reduce costs. At the same time, universality of material selection can be improved, and requirements for accuracy of an equipment for stamping the explosion-proof valve 100 can be reduced. For example, the body 10 may be made of 3003-H14 aluminum (Al) or 1060-0 Al, such that a domestic design can be realized to reduce costs.

According to implementations of a second aspect of the present disclosure, a battery 200 includes the explosion-proof valve 100 of any of the above implementations applicable to the battery 200.

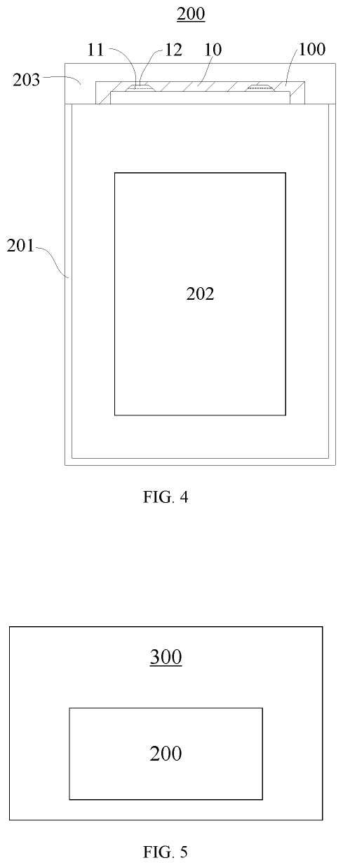

It can be understood that the body 10 of the explosion-proof valve 100 defines the first notch groove 11 and defines the multiple second notch grooves 12 on the basis of the first notch groove 11. Specifically, reference can be made to FIG. 4, and the battery 200 further includes a housing 201, a winding core 202, and a top cover assembly 203. The winding core 202 is located in the housing 201, the top cover assembly 203 seals the housing 201, and the explosion-proof valve 100 is installed in the top cover assembly 203. When a pressure inside the battery 200 is relatively large and reaches a preset value of the explosion-proof valve 100, the explosion-proof valve 100 is exploded, such that the pressure inside the battery 200 can be released from a position of the explosion-proof valve 100. The first notch groove 11 is defined on a side of the top cover assembly 203 close to the winding core 202, and the multiple second notch grooves 12 are defined on the groove wall of the first notch groove 11. A thickness of a groove wall where each of the multiple second notch grooves 12 is defined in the first notch groove 11 in a direction perpendicular to the body 10 is smaller than a thickness of a groove wall where each of the multiple second notch grooves 12 is not defined in the first notch groove 11 in the direction perpendicular to the body 10, that is, each of the multiple second notch grooves 12 can reduce a thickness of a groove wall of the first notch groove 11 in the direction perpendicular to the body 10. The first notch groove 11 and the multiple second notch grooves 12 are defined by punching the body 10. Since notch grooves have different depths, the notch grooves have different structural strengths, and regions on which the multiple second notch grooves 12 are defined are easier to be exploded. In addition, the two ends of the first notch groove 11 are not communicated and the two ends of the first notch groove 11 are at an interval, such that when the explosion-proof valve 100 is exploded and a crack is between a middle region of the body 10 and the boss 13, the middle region of the body 10 can still be connected with the boss 13, which avoids splattering of the middle region of the body 10 due to an explosion pressure, and improves safety of using the explosion-proof valve 100.

Therefore, the first notch groove defines the at least one second notch groove 12 on the groove wall of the first notch groove 11, such that a notch depth of the explosion-proof valve 100 can present multiple gradients, the body 10 can have different thicknesses, an explosion pressure can be concentrated at the position where the at least one second notch groove 12 is defined, the explosion pressure can be more concentrated, explosion accuracy and concentration of explosion and stability of an explosion-proof pressure are improved, the explosion-proof valve 100 can be exploded in a particular direction at a designated position according to a preset explosion region, and safety of the battery 200 is improved.

Reference can be made to FIG. 5. According to implementations of a third aspect of the present disclosure, an energy storage device 300 includes the battery 200 of any of the above implementations. According to the energy storage device 300 of the implementations of the present disclosure, the first notch groove 11 defines the at least one second notch groove 12 on the groove wall of the first notch groove 11, such that a notch depth of the explosion-proof valve 100 can present multiple gradients, the body 10 can have different thicknesses, an explosion pressure can be concentrated at a position where the at least one second notch groove is defined, the explosion pressure can be more concentrated, accuracy and concentration of explosion and stability of an explosion-proof pressure are improved, the explosion-proof valve 100 can be exploded in a particular direction at a designated position according to a preset explosion region, and safety of the energy storage device 300 is improved. For example, multiple batteries 200 can be connected in series, in parallel, or in a hybrid manner to form an energy storage device 300.

In the description of the present disclosure, it should be understood that terms such as “center”, “length”, “width”, “thickness”, “upper”, “lower”, “front”, “rear”, “left”, “right”, “top”, “bottom”, “inner”, “outer”, “axial”, “radial”, “circumferential”, etc., indicate orientation or positional relationships based on orientation or positional relationships illustrated in the accompanying drawings. These terms are only for convenience of describing the present disclosure and simplifying description, and do not indicate or imply that a device or an element referred to must have a particular orientation, or constructed or operated in a particular orientation. Thus, these terms cannot be understood as a limitation to the present disclosure.

In the description of the present disclosure, “first feature”, “second feature” may include one or more of the features. In the description of the present disclosure, “multiple” means two or more. In the description of the present disclosure, the first feature being “above” or “below” the second feature may include the first and second features in direct contact, or it may include the first and second features not in direct contact but contact through another feature between them. In the description of the present disclosure, the first feature being “on”, “above” and “on top of” the second feature include the first feature directly above and obliquely above the second feature, or it simply indicates that the first feature has a higher level than the second feature.

In the description of the present specification, the description with reference to the terms “one implementation”, “some implementations”, “exemplary implementations”, “examples”, “specific examples”, “some examples”, etc., means that the specific feature, structure, material or feature described in combination with the implementation or example is included in at least one implementation or example of the present disclosure. In this specification, the schematic representations of the above terms do not necessarily refer to the same implementation or example.

Although the implementations of the present disclosure have been shown and described, those of ordinary skill in the art may understand that various changes, modifications, substitutions, and variants may be made to these implementations without departing from the principle and purpose of the present disclosure. The scope of the present disclosure is defined by the claims and their equivalents.

What is claimed is:

1. An explosion-proof valve applicable to a battery, comprising:
a body;
a first notch groove defined on a side surface of the body; and
at least one second notch groove defined on a groove wall of the first notch groove.

2. The explosion-proof valve of claim 1, wherein the explosion-proof valve comprises a plurality of second notch grooves, and the plurality of second notch grooves are arranged at intervals in a length direction of the first notch groove.

3. The explosion-proof valve of claim 2, wherein at least two of the plurality of second notch grooves have different lengths.

4. The explosion-proof valve of claim 1, wherein each of the at least one second notch groove has a width smaller than the first notch groove.

5. The explosion-proof valve of claim 1, wherein each of the at least one second notch groove has a polygonal cross-section or a semicircular cross-section.

6. The explosion-proof valve of claim 1, wherein the body is provided with a boss at an edge of the side surface of the body, the first notch groove is adjacent to the boss, and the first notch groove is located at a radially inner side of the boss.

7. The explosion-proof valve of claim 6, wherein the first notch groove extends in an extension direction of the boss, and two ends of the first notch groove are spaced apart.

8. The explosion-proof valve of claim 1, wherein the at least one second notch groove is defined on a bottom wall of the first notch groove, and a distance between the bottom wall of the first notch groove and a bottom wall of each of the at least one second notch groove is D, D satisfying 0.015 mm ≤D≤0.025 mm.

9. A battery, comprising:
an explosion-proof valve applicable to the battery, comprising:
a body;
a first notch groove defined on a side surface of the body; and
at least one second notch groove defined on a groove wall of the first notch groove;
a housing;
a winding core located in the housing; and
a top cover assembly sealing the housing, wherein the explosion-proof valve is installed in the top cover assembly, and the first notch groove is defined at a side of the top cover assembly close to the winding core.

10. The battery of claim 9, wherein the explosion-proof valve comprises a plurality of second notch grooves, and the plurality of second notch grooves are arranged at intervals in a length direction of the first notch groove.

11. The battery of claim 9, wherein each of the at least one second notch groove has a width smaller than the first notch groove.

12. The battery of claim 9, wherein each of the at least one second notch groove has a polygonal cross-section or a semicircular cross-section.

13. The battery of claim 9, wherein the body is provided with a boss at an edge of the side surface of the body, the first notch groove is adjacent to the boss, and the first notch groove is located at a radially inner side of the boss.

14. The battery of claim 13, wherein the first notch groove extends in an extension direction of the boss, and two ends of the first notch groove are spaced apart.

15. An energy storage device, comprising:
a battery, comprising:
an explosion-proof valve applicable to the battery, comprising:
a body;
a first notch groove defined on a side surface of the body; and
at least one second notch groove defined on a groove wall of the first notch groove;
a housing;
a winding core located in the housing; and
a top cover assembly sealing the housing, wherein the explosion-proof valve is installed in the top cover assembly, and the first notch groove is defined at a side of the top cover assembly close to the winding core.

16. The energy storage device of claim 15, wherein the explosion-proof valve comprises a plurality of second notch grooves, and the plurality of second notch grooves are arranged at intervals in a length direction of the first notch groove.

17. The energy storage device of claim 16, wherein at least two of the plurality of second notch grooves have different lengths.

18. The energy storage device of claim 15, wherein the body is provided with a boss at an edge of the side surface of the body, the first notch groove is adjacent to the boss, and the first notch groove is located at a radially inner side of the boss.

19. The energy storage device of claim 18, wherein the first notch groove extends in an extension direction of the boss, and two ends of the first notch groove are spaced apart.

20. The energy storage device of claim 15, wherein the at least one second notch groove is defined on a bottom wall of the first notch groove, and a distance between the bottom wall of the first notch groove and a bottom wall of each of the at least one second notch groove is D, D satisfying 0.015 mm≤D≤0.025 mm.
